(19) United States
(12) Patent Application Publication
(10) Pub. No.: US 2003/0186587 A1
(43) Pub. Date: Oct. 2, 2003

(54) Hollow connector

(76) Inventors: Chen-Chun Kao, Taipei (TW); Ming-De Chen, Sanchung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/392,028

(22) Filed: Mar. 18, 2003

(30) Foreign Application Priority Data
Mar. 29, 2002 (TW) 091106438

(51) Int. Cl. H01R 13/66

(52) U.S. Cl. 439/620

(57) ABSTRACT

A connector for positioning at a circuit board is disclosed. The connector includes a hollow base and a number of contact points. The hollow base enables the connector to firmly sit at the circuit board and encompasses an electronic device therein. The contact points are at the bottom surface of the hollow base for electrically coupling with the circuit board. Another combination type connector is also disclosed. The combination type connector includes an external connector and an internal connector. The external connector includes a hollow base and a number of first contact points at its bottom surface. The hollow base enables the connector to firmly sit at the circuit board and encompasses an electronic device on the circuit board. The first contact points are electrically coupled with the circuit board. The internal connector is at the hollow base of the external connector and has the second contact points for electrically connecting with the circuit board.

This application claims the benefit of Taiwan application Serial No. 091106438, filed Mar. 29, 2002.

### BACKGROUND OF THE INVENTION

1. Field of the Invention

The invention relates in general to a connector, and more particularly to a connector with a hollow base.

2. Description of the Related Art

As a result of the advance of technology, various electrical products are available in the market. In particular, portable electrical products, such as cellular phones, become very popular because of the mobility and the diversity of their function.

To make the portable electrical products user-friendlier, the features thereof need to be minimized in terms of weight and size. One of the aspects to reduce the size is to eliminate the space occupied by the electronic devices, such as connectors. The minimization of the space occupied by connectors is now of high demand and a hot issue to study on.

The conventional connector 100 positioned on a circuit board 120 is as shown in FIG. 1, which includes contact points 110 for being electrically coupled with the circuit board 120. The connector 100 is flat attached to the circuit board 120 and is substantially at the same level of the circuit board 120 so that every single connector occupies a certain surface area of the circuit board 120. So the surface area on the circuit board 120 occupied by connectors increases along with the increasing number of the connector and are hardly possible to reduce.

To sum up, the conventional connector has the following drawbacks:

1. Only one way of connecting the connector and the circuit board is available.

2. The flat attachment of the connector to the circuit board makes the size shrinking and the cost down of the circuit board impossible.

3. The final electrical products formed by the conventional connector and the circuit board are hard to be minimized in terms of size.

### SUMMARY OF THE INVENTION

It is therefore an object of the invention to provide a connector for positioning at a circuit board. The connector includes a hollow base and a number of contact points. The hollow base enables the connector to firmly sit at the circuit board and encompasses an electronic device therein. The contact points are at the bottom surface of the hollow base for electrically coupling with the circuit board.

It is therefore a further object of the invention to provide a combination type connector. The combination type connector includes an external connector and an internal connector. The external connector includes a hollow base and a number of first contact points at its bottom surface. The hollow base enables the connector to firmly sit at the circuit board and encompasses an electronic device on the circuit board. The first contact points are electrically coupled with the circuit board. The internal connector is at the hollow base of the external connector and has the second contact points for electrically connecting with the circuit board.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows the conventional connector positioned on a circuit board.

FIG. 2A illustrates the combination connector according to a preferred embodiment of the invention.

FIG. 2B is the bottom view of the external connector as shown in FIG. 2A.

FIG. 3A shows a combination connector including a SIM card connector and a battery connector.

FIG. 3B shows the assembly of the external SIM card connector and the internal battery connector.

FIG. 3C shows the bottom view of the combination connector in FIG. 3B. The assembly of the external SIM card connector 310 and the internal battery connector 320 is shown in FIG. 3B.

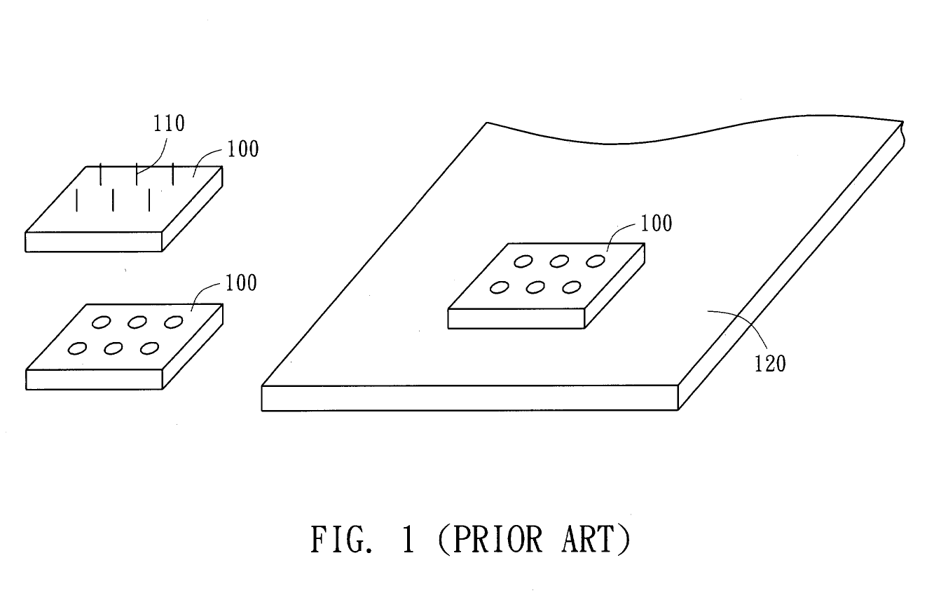

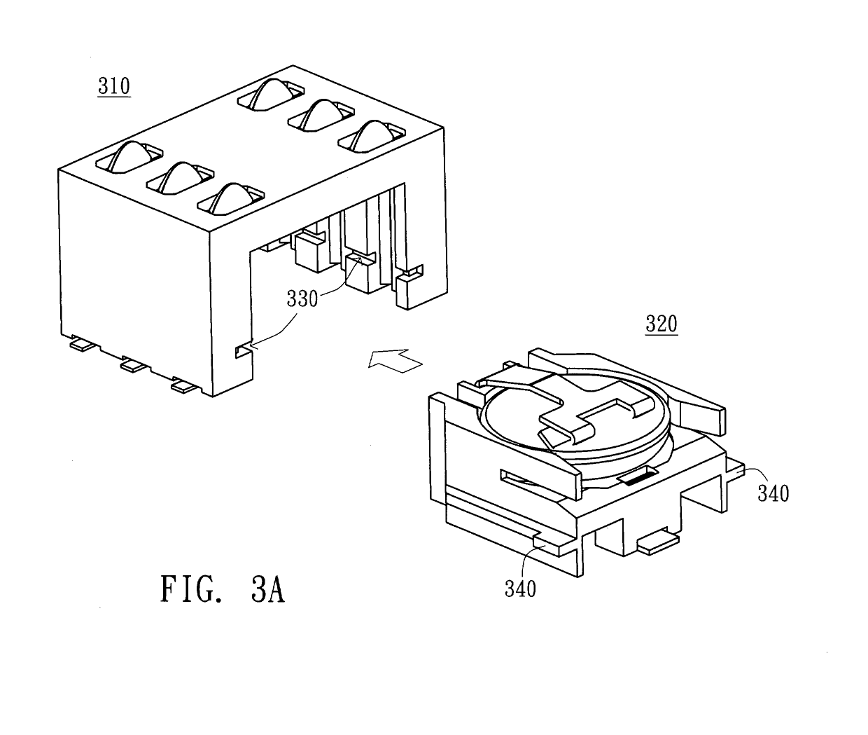

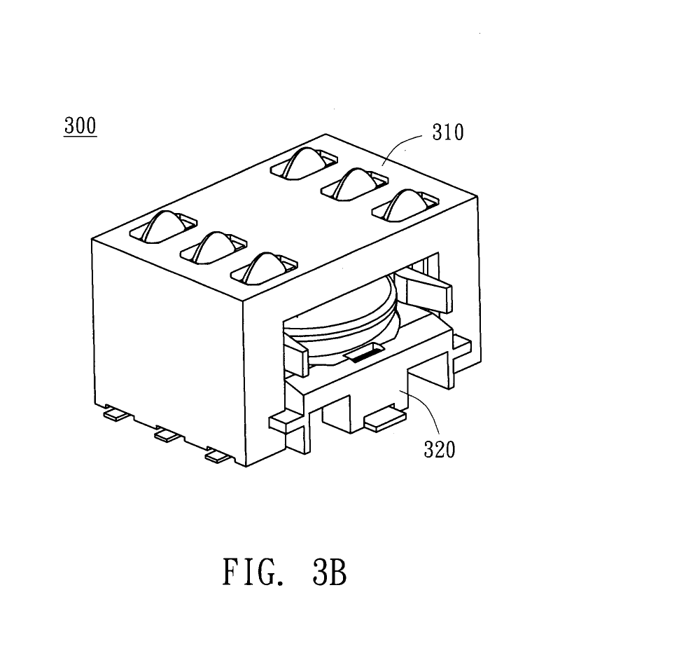

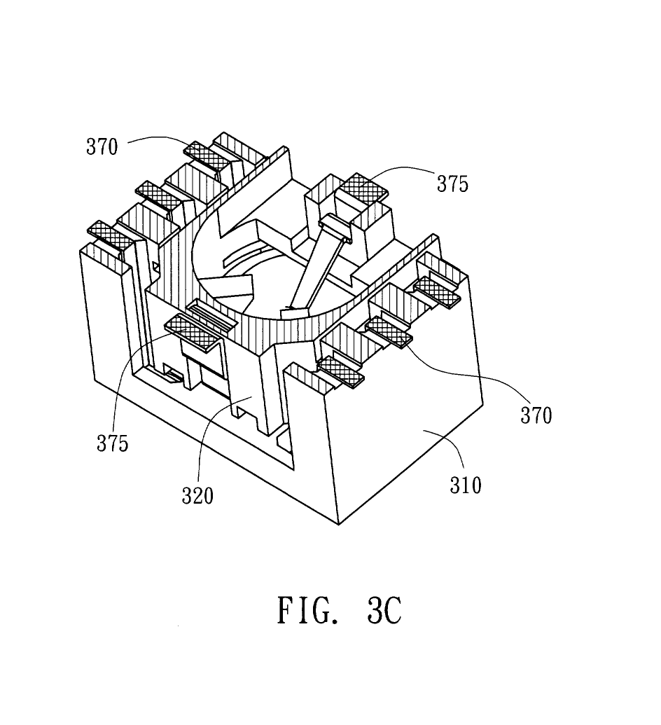

Referring to FIG. 3C, the bottom view of the combination connector in FIG. 3B is shown.

### DETAILED DESCRIPTION OF THE INVENTION

The connector of the invention is designed for overcoming the drawbacks of the conventional connectors. The conventional connectors are coupled to the circuit board by laying substantially at the same level as the circuit board and thus occupies a certain area of the circuit board surface. The surface area of the circuit board therefore can not be minimized due to the existence of numerous conventional laying-connectors.

The connector of the invention includes a hollow base, within which other electronic devices or connectors can be mounted. While the mounted connector is also designed according to the spirit of the invention, a further electronic device or connector can be mounted in the hollow base thereof. As a result, not only the way of depositing connectors becomes more flexible but also the surface area of the circuit board occupied by the connectors and other electronic devices can be dramatically reduced. Consequently, the portable electronic devices containing the connectors of the invention can be minimized in terms of size. The detailed structure of the connector with a hollow base is described as follows.

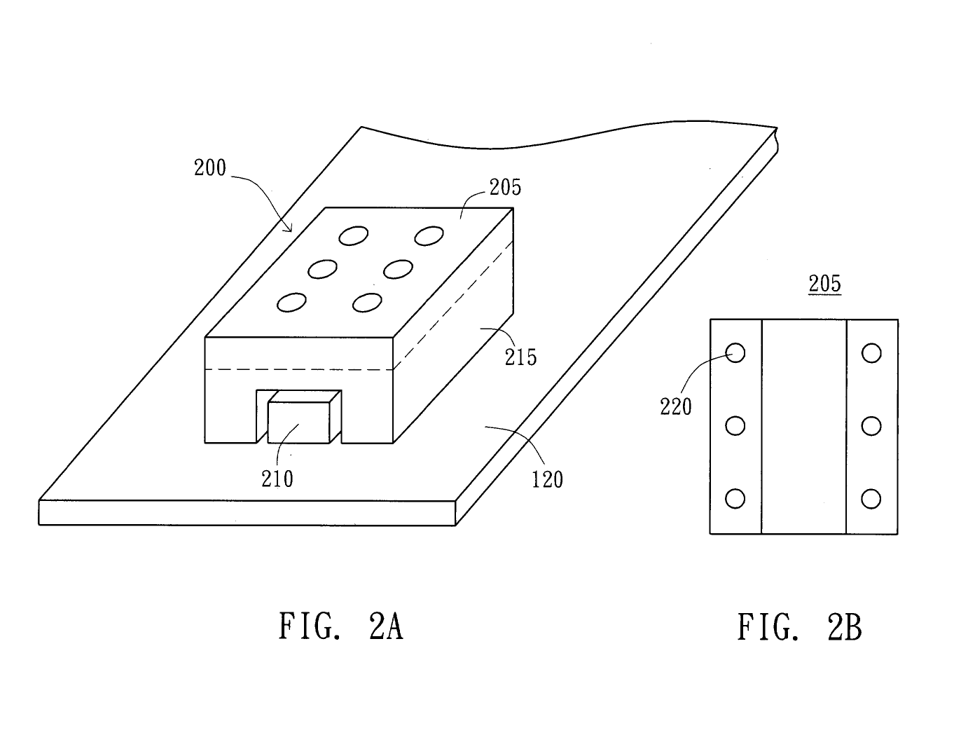

Please refer to both FIG. 2A and FIG. 2B, wherein FIG. 2A illustrates the combination connector according to a preferred embodiment of the invention and FIG. 2B is the bottom view of the external connector as shown in FIG. 2A. The combination connector 200 is preferably positioned on the circuit board 120 and includes at least the external connector 205 and the internal connector 210. The external connector 205 can be, for example, a SIM card connector and the internal connector 210 can be, for example, a battery connector or, more specifically, a lithium battery connector. The bottom of the external connector 205 is hollow so that the internal connector 210 can be mounted therein. As shown in FIG. 2A, for the convenience of clearly illustrating the structure of the external connector 205, the hollow portion of the external connector 205 below the dashed line is defined as the hollow base 215. The hollow base 215 acts as a medium of the external connector 205 to stably connect with the circuit board 120. However, in real practice, the external connector 205 is an unitary device. That is, the hollow base 215 is formed without separating from the main body of the external connector 205. On the bottom surface of the hollow base 215, a number of the first contact points 220 are formed to be electrically coupled with the wiring of the circuit board 120. Also, the internal connector 210 mounted inside the hollow base 215 includes numerous the second contact points (not shown) on the bottom surface thereof in order to be electrically coupled with the circuit board 120. To emphasis the inventive scope of the invention and simplify the drawings, the second contact points are not shown.

Further modification of the above-mentioned combination connector 200 can be made without going beyond the scope of the invention. For example, the internal connector 210 within the hollow base 205 can be replaced by any other electronic devices, such as resistor or capacitor, according to the practical requirements. Or the existing internal connector 210 can be designed to have a hollow base as the external connector 205 and thus be able to further encompass other electronic devices.

Referring to FIG. 3A, a combination connector including a SIM card connector and a battery connector is shown. The SIM card connector 310 acts as the external connector and the battery connector 320 acts as the internal connector. The interior of the hollow base of the SIM card connector 310 includes two guiding recesses 330 and the outer surface of the battery connector 320 includes two sliding tracks 340 complementary to the two guiding recesses 330. So the battery connector 320 can be slid into the hollow base of the SIM card connector 310 along the guiding recesses 330 and attached firmly thereto. The assembly of the external SIM card connector 310 and the internal battery connector 320 is shown in FIG. 3B.

Referring to FIG. 3C, the bottom view of the combination connector in FIG. 3B is shown. On the bottom surfaces of the SIM card connector 310 and the battery connector 320, numerous spring leaf pins 370 or metal contact points 375 are formed respectively to enable the SIM card connector 310 and the battery connector 320 to electrically contact with the circuit board. By the design of hollow base of the invention, on the same surface area of the circuit board, both a SIM card connector 310 and a battery connector can be positioned. Compared with the conventional layout of the two connectors, the combination connector of the invention occupies much less surface area of the circuit board.

It is therefore apparent that the apparatus of the invention includes at least the following advantages:

1. Alternative ways of connecting the connector to the circuit board are available.

2. The connector with a hollow base is capable of encompassing additional electronic devices or connectors so that larger number of devices can be positioned in a limited surface area of the circuit board, compared with the conventional connector.

3. The novel ways of positioning connectors as disclosed in the invention effectively reduce the surface area of the circuit board and thus make the minimization of the final electrical products real.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A hollow connector suitable for positioning at a circuit board at least comprising:
a hollow base for attaching the hollow connector onto the circuit board, wherein the hollow base is capable to encompassing an additional electronic device; and
a plurality of contact points positioning at a bottom surface of the hollow base for electrically coupling with the circuit board.

2. The hollow connector as claimed in claim 1, wherein the additional electronic device is a resistor.

3. The hollow connector as claimed in claim 1, wherein the additional electronic device is a capacitor.

4. The hollow connector as claimed in claim 1, wherein the hollow connector is a SIM card connector.

5. A combination connector suitable for positioning at a circuit board at least comprising:
an external connector comprising:
a hollow base for attaching the external connector onto the circuit board, and
a plurality of first contact points positioning at a bottom surface of the hollow base for electrically coupling with the circuit board; and
an internal connector positioning inside the hollow base of the external connector, wherein a plurality of the second contact points are positioned at a bottom surface of the internal connector for electrically coupling with the circuit board.

6. The combination connector as claimed in claim 5, wherein the internal connector has a hollow base for encompassing an electronic device.

7. The combination connector as claimed in claim 5, wherein an interior of the hollow base of the external connector comprises a guiding recess and an outer surface of the internal connector comprises a sliding track complementary to the guiding recess so that the internal connector can be slid into the hollow base of the external connector along the guiding recess.

8. The combination connector as claimed in claim 5, wherein the external connector is a SIM card connector.

9. The combination connector as claimed in claim 5, wherein the internal connector is a battery connector.

10. The combination connector as claimed in claim 9, wherein the battery connector is a lithium battery connector.
